(19) United States
(12) Patent Application Publication
(10) Pub. No.: US 2024/0311441 A1
(43) Pub. Date: Sep. 19, 2024

(54) DOMAIN-INDEPENDENT LIFELONG PROBLEM SOLVING THROUGH DISTRIBUTED ALIFE ACTORS

(71) Applicant: Cognizant Technology Solutions U.S. Corporation, College Station, TX (US)

(72) Inventors: Babak Hodjat, Dublin, CA (US); Hormoz Shahrzad, Dublin, CA (US); Risto Miikkulainen, Stanford, CA (US)

(73) Assignee: Cognizant Technology Solutions U.S. Corporation, College Station, TX (US)

(21) Appl. No.: 18/603,744

(22) Filed: Mar. 13, 2024

Related U.S. Application Data
(60) Provisional application No. 63/489,910, filed on Mar. 13, 2023.

(51) Int. Cl. G06F 17/11

(52) U.S. Cl. CPC G06F 17/11

(57) ABSTRACT

A domain-independent problem-solving system and process addresses domain-specific problems with varying dimensionality and complexity, solving different problems with little or no hyperparameter tuning, and adapting to changes in the domain, thus implementing lifelong learning.

### CROSS-REFERENCE TO RELATED APPLICATIONS

The present application claims the benefit of priority to U.S. Provisional Patent Application No. 63/489,910, “DOMAIN-INDEPENDENT LIFELONG PROBLEM SOLVING THROUGH DISTRIBUTED ALIFE ACTORS” which was filed on Mar. 13, 2023 and which is incorporated herein by reference in its entirety.

Cross-reference is made to co-owned U.S. Patent Publication No. US2018/0114118 entitled Alife Machine Learning System and Method and PCT Publication No. WO2016207731A2 entitled Alife Machine Learning System and Method, as well as the following inventor publication Hodjat, et al., “DIAS: A Domain-Independent Alife-Based Problem-Solving System” In Proceedings of the 2022 Conference on Artificial Life, Jul. 18-22, 2022, which are incorporated herein by reference in their entireties.

### BACKGROUND

### Field of the Invention

The subject matter described herein, in general, relates to a domain-independent problem-solving system and process that can address problems with varying dimensionality and complexity, solve different problems with little or no hyperparameter tuning, and adapt to changes in the domain, thus implementing lifelong learning.

### Description of Related Art

Ecosystems in nature consist of diverse organisms each with a generic goal to survive. Survival may require different strategies and actions at different times. Emergent behavior from the collective actions of these organisms then makes it possible for the ecosystem as a whole to adapt to a changing world, i.e. solve new problems as they appear.

Such continual adaptation is often necessary for artificial agents in the real world as well. As a matter of fact, the field of reinforcement learning was initially motivated by such problems: The agent needs to learn while performing the task. While many offline extensions now exist, minimizing regret and finding solutions in one continuous run makes sense in many domains.

For instance, there are domains where the fundamentals of the domain are subject to rapid and unexpected change. For instance in stock trading, changes to the micro structure of the market, such as decimalization in 2001, or the a large volume of trade being handled by high frequency trading systems as of the early 2010s, introduce fundamental changes to the behavior of the stocks. In common parlance, such shifts are known as ‘regime change’, and require trading strategies to be adjusted or completely rethought. Another example is supply-chain management processes, which were drastically affected due to the abrupt changes in demand patterns introduced by the COVID-19 pandemic of 2020.

More generally, any control system for functions that exhibit chaotic behavior needs to adapt rapidly and continuously. Similarly in many game-playing domains opponents improve and change their strategies as they play, and players need to adapt. There are also domains where numerous similar problems need to be solved and there is little time to adapt to each one, such as trading systems with a changing portfolio of instruments, financial predictions for multiple businesses/units, optimizing multiple industrial production systems, optimizing growth recipes for multiple different plants, and optimizing designs of multiple websites.

However, current Artificial Intelligence (AI) systems are not adaptive in this manner. They are strongly tuned to each particular problem, and adapting to changes in it and to new problems requires much domain-specific tuning and tailoring.

The natural ecosystem approach suggests a possible solution: Separate the AI from the domain. A number of benefits could result. First, the AI may be improved in the abstract; it is possible to compare versions of it independently of domains. Second, the AI may more easily be designed to be robust against changes in the domain, or even switches between domains. Third, it may be designed to transfer knowledge from one domain to the next. Fourth, it may be easier to make it robust to noise, task variation, and unexpected effects, and to changes to the action space and state space.

In most population-based problem-solving approaches, such as Genetic Algorithms (GA; Mitchell, An introduction to genetic algorithms. MIT Press, 1996; Eiben and Smith, Introduction to evolutionary computing. Springer, 2015), Particle Swarm Optimization (Sengupta et al., Particle swarm optimization: A survey of historical and recent developments with hybridization perspectives. Machine Learning and Knowledge Extraction, 1(1), 157-191, 2018; Rodriguez and Reggia, Extending Self-Organizing Particle Systems to Problem Solving. Artificial Life, 10, 379-395, 2004), and Estimation of Distribution Algorithms (Krejca and Witt, Theory of estimation-of-distribution algorithms. In Theory of evolutionary computation (pp. 405-442). Springer, 2020), each population member is itself a candidate solution to the problem. In contrast, in DIAS, the entire population together represents the solution.

Much recent work in Artificial Life concentrates on exploring how fundamentals of biological life, such as reproduction functions, hyper-structures, and higher order species, evolved (Gershenson et al., Self-organization and artificial life: A review. arXiv:1804.01144, 2018). However, some Alife work also focuses on potential robustness in problem solving (Hodjat and Shahrzad, Introducing a dynamic problem solving scheme based on a learning algorithm in artificial life environments. Proceedings of 1994 IEEE International Conference on Neural Networks, 4, 2333-2338, 1994). For instance, in Robust First Computing as defined by Ackley and Small (Indefinitely scalable computing=artificial life engineering. ALIFE 14: The Fourteenth International Conference on the Synthesis and Simulation of Living Systems, 606-613, 2014), there is no global synchronization, perfect reliability, free communication, or excess dimensionality. DIAS complies to these principles as well. While it does impose periodic boundary conditions, these boundaries can expand or retract depending on the dimensionality of the problem.

This approach is most closely related to Swarm Intelligence systems (Bansal et al., Evolutionary and swarm intelligence algorithms (Vol. 779). Springer , 2019), such as Ant Colony Optimization (Deng et al., An improved ant colony optimization algorithm based on hybrid strategies for scheduling problem. IEEE Access, 7, 20281-20292, 2019). The main difference with the DIAS solution is that the problem domain is independent from the environment in which the actors survive, i.e. the ecosystem, and a common mapping is provided from the problem domain to the ecosystem. This approach allows for any change in the problem domain to be transparent to the DIAS process, which makes it possible to change and switch domains without reprogramming or restarting the actor population.

Several other differences from prior work result from this separation between actors and problem domains. First, the algorithms that the actors run can be selected and improved independently of the domain and need not be determined a priori. Second, the fitness function for the actors, as well as the mapping between the domain reward function and the actors' reward function, is predefined and standardized, and need not be modified to suit a given problem domain. Third, the actors' state and action spaces are fixed regardless of the problem domain. Fourth, there is no enforced communication mechanism among the actors. While the actors do have the facility to communicate point-to-point and communication might emerge if needed, it is not a precondition to problem solving.

In terms of prior work in the broader field of Universal AI and Domain Independence (Hutter, A theory of universal artificial intelligence based on algorithmic complexity. arXiv:cs-ai-0004001, 2000), most approaches are limited to search heuristics, such as extensions to the A* algorithm (Stern, Domain-dependent and domain-independent problem solving techniques. IJCAI, 6411-6415, 2019). Such approaches still require domain knowledge such as the goal state, state transition operators, and costs. While efficient, these approaches lack robustness, and are designed to work on a single domain at a time. They do not do well if the domain changes during the optimization process. In the case of domain-independent planning systems (Della Penna et al., UPMurphi: A tool for universal planning on PDDL+ problems [19:106-113]. Proc. International Conference on Automated Planning and Scheduling, 2009), the elaborate step of modeling the problem domain is still required. Depending on the manner by which such modeling is done, the system will have different performance. In this sense DIAS aims at more general domain-independent problem solving than prior approaches.

### SUMMARY OF CERTAIN EMBODIMENTS

The embodiments herein aim at designing such a problem-solving system and demonstrating its feasibility in a number of benchmark examples. In this Domain Independent Alife-based Problem Solving System (DIAS), a population of actors cooperate in a spatial medium to solve the current problem, and continue doing so over the span of several changing problems. The experiments will demonstrate that: (1) The behaviors of each actor are independent from the problem definition; (2) Solutions emerge continually from collective behavior of the actors; (3) The actor behavior and algorithms can be improved independently of the domains; (4) DIAS scales to problems with different dimensionality and complexity; (5) Very little or no hyperparameter tuning is required between problems; (6) DIAS can adapt to a changing problem domain, implementing lifelong learning; and (7) Collective problem-solving provides an advantage in scaling and adaptation. DIAS can thus be seen as a promising starting point for scalable, general, and adaptive problem solving, based on principles of Artificial Life.

In a first exemplary embodiment, a domain-independent evolutionary process for solving a problem, the process includes: initializing a first population of independent, individual actors existing on a three-dimensional (x, y, z) grid, wherein x is elements of a domain-action vector, y is elements of a domain-state vector, and z is a space for messaging, and further wherein each of the individual actors is initialized to solve the problem by; (i) applying each of the individual actors to the problem during a first time interval in an attempt to solve the problem until the first time interval is terminated; (ii) determining fitness F of the population of individual actors to solve the problem during the first time interval; (iii) assigning credit to the determined fitness F to individual actors, wherein each individual actor's credit is f, (iv) removing individual actors based on at least a change in energy Δe; (v) selecting multiple individual actors for procreation having credit values above a minimum requirement for f, (vi) generating new individual actors by procreating the selected multiple individual actors; (vii) adding the new individual actors to the first population to establish a second population of individual actors; and repeating steps (i) to (vii) for a predetermined number of time intervals or until a solution to the problem is discovered.

In a second exemplary embodiment, a domain-independent evolutionary process for solving a problem, the process includes: establishing three-dimensional grid including domain-action space along the x-axis and domain-state space along the y-axis, wherein domain action is a vector A including one or more elements Aₓ mapped to a different x-location and domain state is a vector S including elements Sy mapped to different y-locations; mapping a first population of actors to different (x, y, z) locations the grid, wherein there are one or more actors for each (x, y)-location of the grid and for each actor, actor-state and actor-action exist independent of domain; during each domain time step t, loading a current domain-state vector S into the grid, wherein each (x, y, z) location is updated with S domain-state element S_{y}; inputting by each actor in the first population its current actor state vector σ; issuing by each actor, one of an action α or no action as output, wherein when an action α is output, further writing a domain-action suggestion αₓ in their location creating a domain-action vector A and averaging domain-action suggestions αₓ are averaged across all locations with the same x to form its elements Aₓ, when no aₓ were written, Aₓ(t−1) is used with Aₓ(−1)=0 and a resulting action vector A is passed to the domain, which executes it, resulting in a new domain state.

In a third exemplary embodiment, at least one non-transitory computer readable medium programmed to implement a domain-independent evolutionary process for solving a problem, the process includes: initializing a first population of independent, individual actors existing on a three-dimensional (x, y, z) grid, wherein x is elements of a domain-action vector, y is elements of a domain-state vector, and z is a space for messaging, and further wherein each of the individual actors is initialized to solve the problem by; (i) applying each of the individual actors to the problem during a first time interval in an attempt to solve the problem until the first time interval is terminated; (ii) determining fitness F of the population of individual actors to solve the problem during the first time interval; (iii) assigning credit to the determined fitness F to individual actors, wherein each individual actor's credit is f, (iv) removing individual actors based on at least a change in energy Δe; (v) selecting multiple individual actors for procreation having credit values above a minimum requirement for f, (vi) generating new individual actors by procreating the selected multiple individual actors; (vii) adding the new individual actors to the first population to establish a second population of individual actors; and repeating steps (i) to (vii) for a predetermined number of time intervals or until a solution to the problem is discovered.

### BRIEF SUMMARY OF FIGURES

Example embodiments will become more fully understood from the detailed description given herein below and the accompanying drawings, wherein like elements are represented by like reference characters, which are given by way of illustration only and thus are not limitative of the example embodiments herein.

FIG. 1 exemplifies the general design of a DIAS: A Domain-Independent Alife-Based Problem-Solving System (“DIAS”) system in accordance with an embodiment herein.

FIGS. 2a, 2b, 2c show DIAS with the DQN actor type solving 1-XOR (FIG. 2a), 2-XOR (FIGS. 2b), and 3-XOR (FIG. 2c) in 10 independent runs in accordance with an embodiment herein.

FIGS. 3a, 3b, 3c show the number of time intervals needed to solve the 1-XOR (FIG. 3a), 2-XOR (FIGS. 3b) and 3-XOR (FIG. 3c) problems in 10 independent runs.

FIGS. 4a, 4b, 4c show the number of time intervals needed to solve the 1-XOR (FIG. 4a), 2-XOR (FIGS. 4b) and 3-XOR (FIG. 4c) problems in 10 independent runs with 10% noise added to the XOR outputs.

FIG. 5 provides an example actor that solves the 1-XOR problem in accordance with an embodiment herein.

FIGS. 6a, 6b, 6c, 6d show DIAS solving different kinds of problems in the OpenAIGym domain in accordance with embodiments herein.

FIGS. 7a, 7b, 7c show population dynamics in a sample run of the CartPole problem of FIG. 6c in accordance with an embodiment herein.

FIG. 8 provides an example actor from a population that solves the CartPole problem in accordance with an embodiment herein.

FIGS. 9a and 9b shows the adaptability of DIAS to changing problems in accordance with an embodiment herein.

FIG. 10a, 10b, 10c show population dynamics in adapting to new problems in a sample run (Run 1 in FIGS. 9a, 9b) in accordance with an embodiment herein.

FIGS. 11a, 11b show DIAS adapting to both easy and hard problems in accordance with an embodiment herein.

FIG. 12 shows DIAS adapting to changes between different problem domains in accordance with an embodiment herein.

### DETAILED DESCRIPTION

A population of independent actors is set up with the goal of surviving in a common environment called a geo. The input and output dimensions of the domain are laid out across the geo. Each actor sees only part of the geo, which requires that they cooperate in discovering collective solutions. This design separates the problem-solving process from the domain, allowing different kinds of actors to implement it, and makes it scalable and general. The population adapts to new problems through evolutionary optimization, driven by credit assignment through a contribution measure.

### Geo

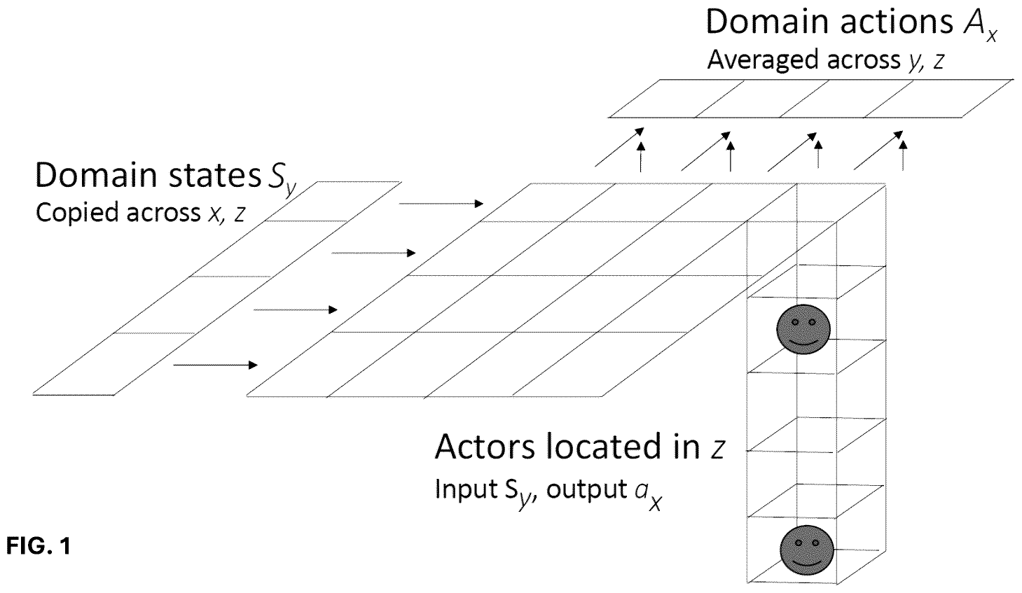

Actors are placed on a three-dimensional grid called geo (FIG. 1). The dimensions of the grid correspond to the dimensions of the domain-action space (along the x-axis) and the domain-state space (along the y-axis). More specifically, domain action is a vector A; each element Aₓ of this vector is mapped to a different x-location. Similarly, domain state is a vector S, and its elements Sy are mapped to different y-locations in the geo. There can be multiple actors for each (x, y)-location of the grid. The z-locations form a space that the actors can occupy and use for messaging. These actors live in different locations of the z dimension. Each (x, y, z) location may contain an actor, as well as a domain-action suggestion and a message, both of which can be overwritten by the actor in that location. The grid thus maps the domain space to an actor space where problems can be solved in a domain-independent manner.

### Actors

An actor is a decision-making unit taking an actor-state vector σ as its input and issuing an actor-action vector α as its output at each domain time step. All actors operate in the same actor-state and actor-action spaces, regardless of the domain. Each actor is located in a particular (x, y, z) location in the geo grid and can move to a geographically adjacent location. Each actor is also linked to a linked location (x′, y′, z′) elsewhere in the geo. This link allows an actor to take into account relationships between two domain-action elements (Aₓ and A_{x′}) and two domain-state elements (S_{y} and S′_{Y}) and to communicate with other actors via messages. Thus, it focuses on a part of the domain, and constitutes a part of a collective solution.

The actor-action vectors α consist of the following actions: Write a domain-action suggestion aₓ in the current location in the geo; Write a message in the current location in the geo; Write actor's reproduction eligibility; Move to a geographically adjacent geo location; Change the coordinates of the linked location; NOP.

The actor-state vectors σ consist of the following data: Energy e: real≥0; Age: integer≥0; Reproduction eligibility: True/False; Coordinates in the current location: integer x, y, z≥0; Message in the current location: [0 . . . 1]; Domain-action suggestion ax in current location: [0 . . . 1]; Domain-state value Sy in the current location: [0 . . . 1]; Coordinates in the linked location: integer x′, y′, z′≥0; Message in the linked location: [0 . . . 1]; Domain-action suggestion ax′ in linked location: [0 . . . 1]; Domain-state value S_{y′} in the linked location: [0 . . . 1].

Depending on the actor type, actors may choose to keep a history of actor states and refer to it in their decision making.

### Problem-Solving Process

Algorithm 1 outlines the computer-implemented DIAS problem-solving process. It proceeds through time intervals (in the main while loop). Each interval is one attempt to solve the problem, i.e. a fitness evaluation of the current system. Each attempt consists of a number of interactions with the domain (in the inner while loop) until the domain issues a terminate signal and returns a domain fitness. The credit for this fitness is assigned to individual actors and used to remove bad actors from the population and to create new ones through reproduction.

More specifically, during each domain time step t, the current domain-state vector S is first loaded into the geo (Step 2.1): Each (x, y, z) location is updated with the domain-state element S_{y}. Each actor then takes its current actor state σ as input and issues an actor action α as its output (Step 2.2). As a result of this process, some actors will write a domain-action suggestion aₓ in their location. A domain-action vector A is then created (Step 2.3): The suggestions aₓ are averaged across all locations with the same x to form its elements Aₓ. If no aₓ were written, Aₓ(t−1) is used (with Aₓ(−1)=0). The resulting action vector A is passed to the domain, which executes it, resulting in a new domain state (Step 2.4).

Algorithm 1

```
Initialize_population; solved=False; interval=0
while interval < maxinterval & ¬ solved do
  1. Initialize_domain; terminated=False; t=0
  2. while t < maxt & ¬ terminated do
```

2.1 Load S
2.2 for each actor do

input σ
output a

2.3 for each x do

Average ax

2.4 Execute A
2.5 t++

```
  3. Obtain F
  4. if ¬ solved then
```

4.1 for each actor do

Calculate f
Calculate Δe
if e = 0 then
Remove_from_population

4.2 Reproduce
4.3 interval++

Actors start the problem-solving process with an initial allotment of energy. After each interval (i.e. domain evaluation), this energy is updated based on how well the actor contributed to the performance of the system during the evaluation (Step 4.1). First, the domain fitness F is converted into domain impact M, i.e. normalized within [0 . . . 1] based on max and min fitness values observed in the past R evaluations:

$$M = ( F - {F}_{m i {n}_{R}} ) / ( {F}_{m {ax}_{R}} - {F}_{m i {n}_{R}} ) \qquad ( 1 )$$

Thus, even though F is likely to increase significantly during the problem-solving process, the entire range [0 . . . 1] is utilized for M, making it easier to identify promising behavior.

Second, the contribution of the actor to M is measured as the alignment of the actor's domain-action suggestions aₓ with the actual action elements Aₓ issued to the domain during the entire time interval. In the current implementation, this contribution c is

$$c = 1 - {min}_{t = 0 … T} ( \vert {A}_{x} ( t ) - {a}_{x} ( t ) \vert ) , \qquad ( 2 )$$

where T is the termination time; thus c∈[0 . . . 1]. The energy update Δe, consists of a fixed cost h and a reward that depends on the impact and the actor's contribution to it. If none of the actor's actions were ‘write αₓ(t)’, i.e. the actor did not contribute to the impact,

$$Δ e = h ( M - 1 ) \qquad ( 3 )$$

that is, the energy will decrease inversely proportional to impact. In contrast, if the actor issues one or more such ‘write’ actions during the interval,

$$Δ e = h ( c M ( 1 - c ) ( 1 - M ) - 1 ) . \qquad ( 4 )$$

In this case, the energy will also decrease (unless M and c are both either 0 or 1) but the relationship is more complex. It decreases less for actors that contribute to good outcomes (i.e. M and c are both high), and for actors that do not contribute to bad outcomes (i.e. the M and c are both low). Thus, regardless of outcomes, each actor receives proper credit for the impact. Overall, energy is a measure of the credit each actor deserves for both leading the system to success as well as keeping it away from failure. If an actor's energy drops to or below zero, the actor is removed from the geo.

For example, if the domain is a reinforcement learning game, like CartPole, each time interval consists of a number of left and right domain actions until the pole drops, or the time limit is reached (e.g. 200 domain time steps). At this point, the domain issues a termination signal, and the fitness F is returned as the number of time steps the pole stayed up. That fitness is scaled to M∈[0 . . . 1] using the max and min F during the R=60,000 previous attempts. If M is high, actors that wrote αₓ values consistently with Aₓ, i.e. suggested left or right at least once when those actions were actually issued to the domain, have a high contribution c, and therefore a small decrease Δe. Similarly, if the system did not perform well, actors that suggested left(right) when the system issued right(left), have a low contribution c and receive a small decrease Δe. Otherwise the Δe is large; such actors lose energy fast and are soon eliminated.

After each time interval, a number of new actors are generated through reproduction (Step 4.2). Two parents are selected from the existing population within each (x, y) column, assuming the total energy in the column is below a threshold Eₘₐₓ. If it is not, the agents are already very good, and evolution focuses on columns elsewhere where progress can still be made, or alternative solutions can be found. In addition, a parent actor needs to meet a maturity age requirement, i.e. it must have been in the system for more than V time intervals and not reproduced for V time intervals. The actor also needs to have reproduction eligibility in its state set to True.

Provided all the above conditions are met, a proportionate selection process is carried out based on actor fitness f, calculated as follows. First, the impact variable M is discretized into L levels: M={b₀, b₁ . . . , b_{L-1}}. Then, for each of these levels bᵢ, the probability pᵢ that the actor's action suggestions align with the actual actions when M=bᵢ is estimated as

$${p}_{i} = P ( c = 1 \vert M = {b}_{i} ) , \qquad ( 5 )$$

where c measures this alignment according to Eq. 2. The same window of R past intervals is used for this estimation as for determining the max and min M for scaling the impact values. Finally, actor fitness f is calculated as alignment-weighted average of the different impact levels bᵢ:

$$f = {{\sum }_{i = 0}}^{L} {p}_{i} {b}_{i} . \qquad ( 6 )$$

Thus, f is the assignment of credit for M to individual actors. Note that while energy measures consistent performance, actor fitness measures average performance. Energy is thus most useful in discarding actors and actor fitness in selecting parents.

Once the parents are selected, crossover and mutation are used to generate offspring actors. What is crossed over and mutated depends on the encoding of the actor type; regardless, each offspring's behavior, as well as its linked-location coordinates, is a result of crossover and mutation. Each pair of parents generates two offspring, whose location is determined randomly in the same (x, y) column as the parents.

Note that the parents are not removed from the population during reproduction, but instead, energy is used as basis for removal. In this manner, the population can shrink and grow, which is useful for lifelong learning. It allows reproduction to focus on solving the current problem, while removal retains individuals that are useful in the long term. Such populations can better adapt to new problems and re-adapt to old ones.

Energy, age, and actor fitness for all actors in an (x, y) column need to be available before reproduction can be done, so computations within the column must be synchronized in Step 4.2. However, the system is otherwise asynchronous across the x and y dimensions, making it possible to parallelize the computations in Steps 2 and 4. Thereby, the system scales to high-dimensional domains in constant time.

### Actor Types

The current version of DIAS employs five different actor types: (1) Random: Selects its next action randomly, providing a baseline for the comparisons; (2) Robot: Selects its next action based on human-defined preprogrammed rules designed for specific problem domains, providing a performance ceiling; (3) Bandit: Selects its next action using a UCB-1 algorithm (not including σ as context). UCB-1 is an exploration-exploitation strategy for multi-armed bandit problems, using upper confidence bounds to balance the trade-off between maximizing rewards and acquiring new knowledge; (4) Q-Learning: Selects its next action using Q-values learned through temporal differences; (5) Rule-set Evolution: Evolves a set of rules to select its next action. A six actor type, DQN, was considered, but for reasons discussed herein is not part of the current implemented version. DQN learns to select its next action using a Deep Q-Learning Neural Network.

Simple Q-learning (Watkins and Dayan, Q-learning. Machine learning, 8(3), 279-292, 1992) was implemented based on the actor's state/action history, with the actor's energy difference from the prior time interval taken as the reward for the current interval. Because the dimensionality of the state/action space is limited by design, a table of Q-values can be learned through the standard reinforcement learning method of temporal differences.

DQN (Mnih et al., Human-level control through deep reinforcement learning. Nature, 518(7540), 529-533, 2015) is a more sophisticated reinforcement learning method that can potentially cope with large state and action spaces. Each actor is a neural network with three fully connected hidden layers of 512, 256, and 64 units with ReLU activation functions. The network is trained to map the actor's current state to its Q-values, using the same temporal difference as the simple Q-learner as the loss. Stochastic gradient descent with mini-batches of size 64 and the Adam optimizer was used, with 0.0001 weight decay and MSE as the loss function. A simple reproduction function copies the weights of a parent actor into the child actor.

Rule-set evolution (Hodjat et al., PRETSL: Distributed probabilistic rule evolution for time-series classification. In Genetic programming theory and practice XIV (pp. 139-148). Springer, 2018) was implemented based on rule sets that consist of a default rule and at least one conditioned rule. Each conditioned rule consists of a conjunction of one or more conditions, and an action that is returned if the conditions are satisfied. Conditions consist of a first and second term being compared, each with a coefficient that is evolved. An argument is also evolved for the action. Evolution selects the terms in the conditions from the actor-state space, and the action from the actor-action space. Rules are evaluated in order, and shortcut upon reaching the first to be satisfied. If none of the rules are satisfied, the default action is returned.

These actor types were evaluated in several standard benchmarks tasks experimentally, as described herein.

### Experiments

DIAS was evaluated in a number of benchmark problems to demonstrate the unique aspects of the approach. The system is shown to be scalable, general, and adaptable. The dynamics of the problem-solving process were characterized and shown to be the source of these abilities.

### Test Domains

In the n-XOR domain, the outputs of n independent XOR gates, each receiving their own input, need to be predicted simultaneously. In order to make the domain a realistic proxy for real-world problems, 10% noise is added to the XOR outputs. While a single XOR (or 1-XOR) problem can be solved by a single actor, solving n>1 of them simultaneously requires a division of labor over the population. The different XOR input elements are in different y-locations and the different predicted outputs in different x-locations. With n>1, no actor can see or act upon the entire problem. Instead, emergent coordination is required to find behaviors that collectively solve all XORs. Increasing n makes the problems exponentially more difficult (i.e. the chance of solving all n XORs by luck is reduced exponentially with n).

The first set of experiments were run in the n-XOR domain. They show that the DIAS design scales to problems of different dimensionality and complexity, both with and without noise. The second set was run in a different domain: OpenAI Gym games, including CartPole, MountainCar, Acrobot, and LunarLander. The same experimental setup was used across all of them without any hyperparameter tuning. This second set shows that DIAS is a general problem-solving approach, requiring little or no parameter tuning when applied to new problems. The third set of experiments were run across these two domains to show that DIAS can adapt to the different problems online, i.e. to exhibit lifelong learning.

### Experimental Setup

Each experiment consists of 10 independent runs of up to 200,000 time intervals. For each domain, the number of x-locations is set to the number of domain actions, and the number of y-locations to the number of domain states (1, 2 for 1-XOR; 2, 4 for 2-XOR; 3, 6 for 3-XOR; 2, 4 for CartPole; 3, 2 for MountainCar; 3, 6 for Acrobot; and 3, 6 for LunarLander). The number of z-locations is constant at 100 in all experiments. The initial population for each (x, y) location is set to 20 actors, placed randomly in z. Each Q-learning actor is initialized with random Q-values, and each rule-set actor with a random default rule. The robot and bandit actors have no random parameters, i.e. they are all identical.

The range R used for scaling domain fitnesses to impact values was 60,000 intervals, and the impact M was discretized into 21 levels {0, 0.05, . . . , 0.95, 1} in calculating actor fitness. Each actor started with an initial energy of 100 units, with a fixed cost h=2 units at each time interval. The energy threshold Eₘₐₓ for reproduction in each (x, y) column was set to the initial energy, i.e. 20*100=2000 (note that while each actor's energy decreases over time, population growth can increase total energy). Reproduction eligibility was set to True at birth, and the reproduction maturity requirement V to 20. Small variations to this setup lead to similar results. In contrast, each of the main design choices of DIAS is important for its performance, as verified in extensive preliminary experiments.

Each experiment can result in one of three end states: (1) the actor population solves the problem; (2) all actors run out of energy before solving the problem and the actor population goes extinct; and (3) the actor population survives but has not solved the problem within the maximum number of time intervals. In practice, it is possible to restart the population if it goes extinct or does not make progress in F after a certain period of time. Restarts were not implemented in the experiments in order to evaluate performance more clearly.

For comparison, direct evolution of rule sets (DE) was also implemented in the DIAS framework. The setup is otherwise identical, but a DE actor receives the entire domain state vector S as its input and generates the entire domain action vector A as its output. DE therefore does not take advantage of collective problem solving. A population of 100 DE actors is evolved for up to 100,000 time intervals through a GA (genetic algorithm) with F as the individual fitness, tournament selection, 25% elitism, and the same crossover and mutation operators as in DIAS.

### Results

Different actor types were first evaluated in preliminary experiments, finding that Rule-set Evolution performed the best. Rule-set Evolution actors were then used to evaluate performance of DIAS in problems of complexity and type, as well as its ability to adapt to changing problems. The dynamics of the problem-solving process were characterized and shown to be the source of these abilities. Analysis of the DQN actor type further demonstrated the power of evolutionary search in collective and continual problem solving.

### Comparing Actor Types

The five actor types described above were each tested in preliminary experiments on 1-XOR, using the same settings. These results demonstrate that collective behavior resulting from the DIAS framework can successfully solve these domains.

The Robot actor specifically written for 1-XOR solves it from the first time interval. Similarly, a custom-designed Robot actor is always successful in the CartPole domain. On the other hand, Random, Bandit, and Simple Q-Learning were not able to solve 1-XOR at all: Each attempt leads to extinction in under 350 time intervals. While it is possible that these actors could solve simpler problems, the search space for 1-XOR is apparently already too large for them.

The DQN actors were able to solve the 1-XOR problem, but could not scale to other n-XOR problems and to the OpenAI Gym domain. As will be discussed in more detail below, DQN does not scale well to large populations, and partial gradient makes SGD difficult.

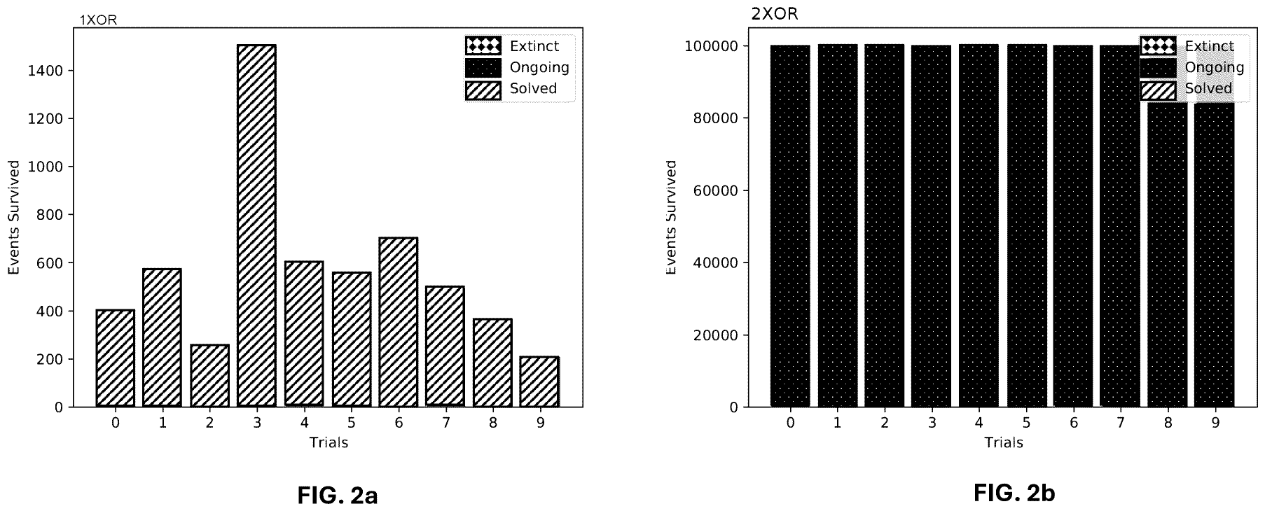

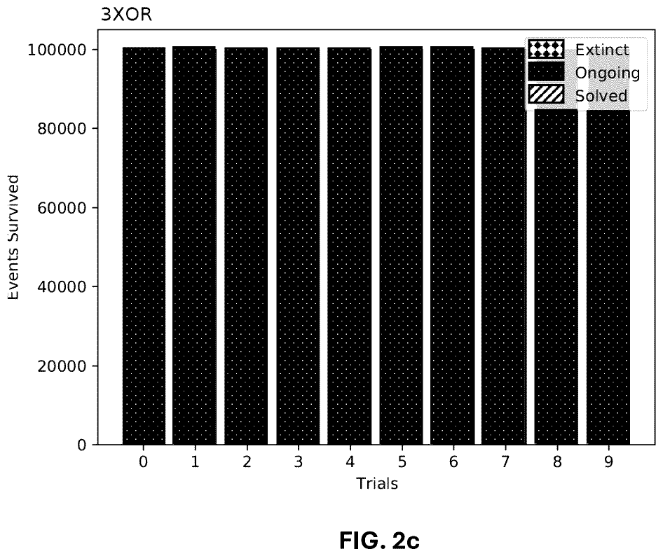

It is interesting to analyze why the DQN actor type was not successful in DIAS. Preliminary experiments showed that the settings for Rule-set Evolution do not work well for DQN, and needed to be modified. First, the 100 time intervals is insufficient for the DQN actors to learn, and therefore initial actor energy was increased to one million (1,000,000). Second, DQN has difficulty coordinating multiple actors in each domain state, and they were thus reduced to only one. As shown in FIGS. 2a, 2b and 2c, with these changes, DIAS with DQN actors was able to solve the 1-XOR problem, but failed at solving the more complex 2-XOR and 3-XOR problems within the allotted number of 100,000 time intervals. The inconsistent partial gradients make it difficult learn proper coordination for collective problem solving; global search methods like Rule-set Evolution are needed instead.

Note that actors in DIAS have only a partial view of the domain state, and they also have agency over only one of the actions in the domain action space. Thus, the value of an actor's action in a given state, i.e., the value function Q(s, a) depends on the behavior of other actors. This limitation can result in contradictory Q-values, making it very difficult to find a useful policy. The gradients result in local hill climbing: They may push the actor in the wrong direction and there is no way for it to recover. Evolution is able to overcome this problem because it does not follow gradients, i.e. it is not based on hill climbing but is a global search method. Such search is essential in a collective problem-solving system such as DIAS.

Thus, the preliminary experiments indicated that DIAS works best with the Rule-set Evolution actor type; it will therefore be used in the main experiments below.

### Scaling to Problems of Varying Complexity

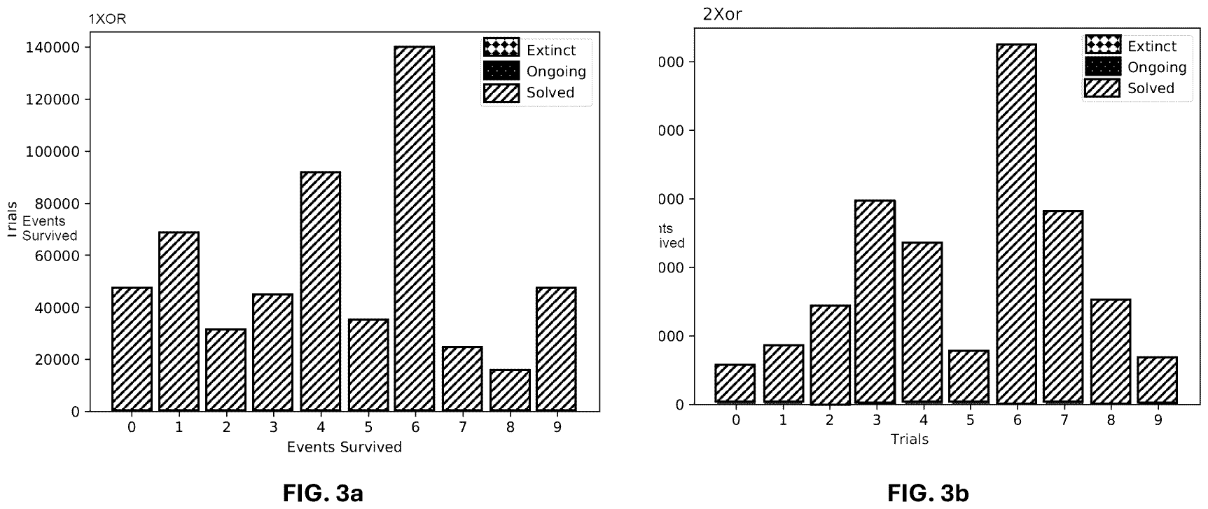

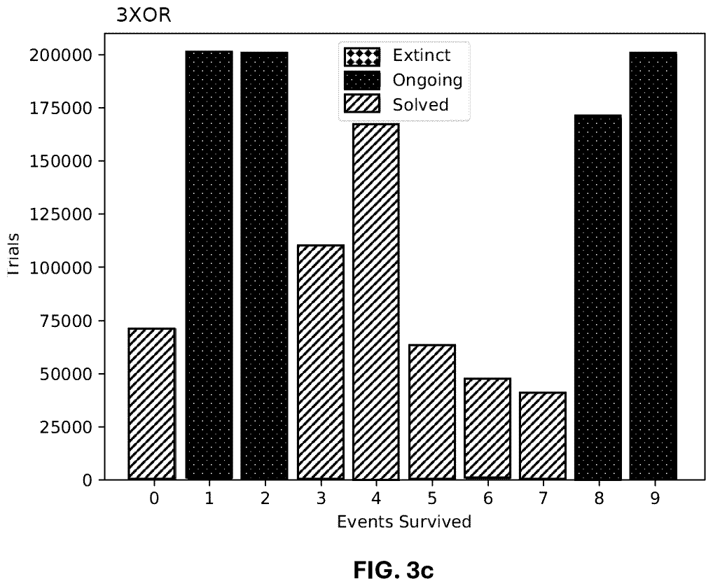

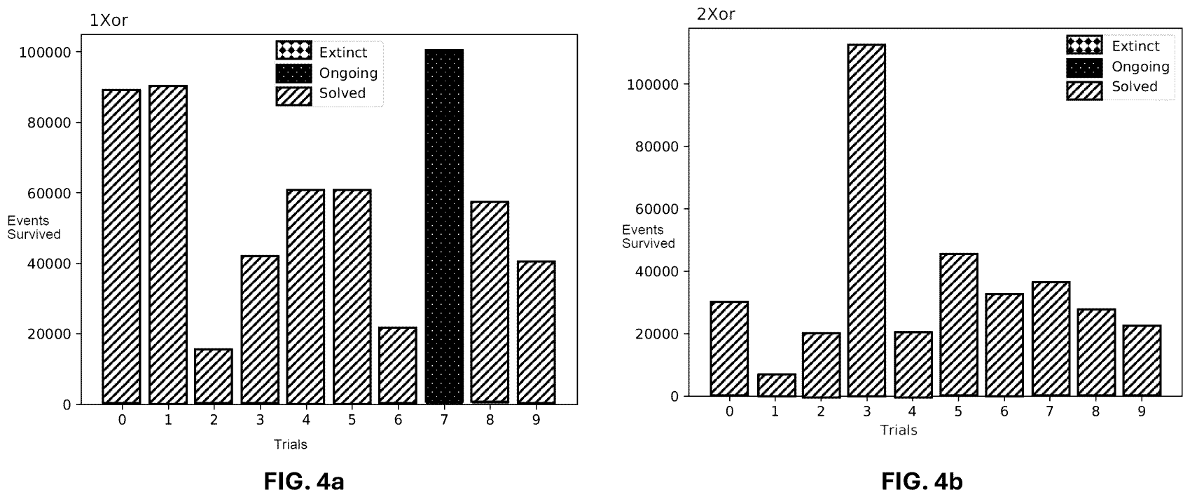

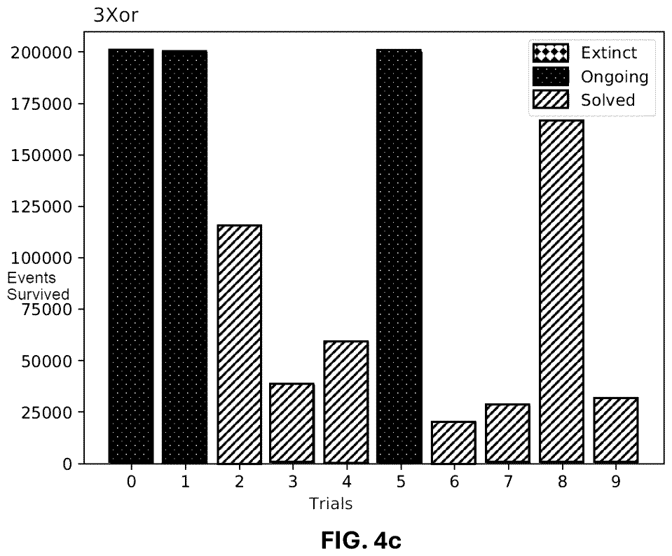

The first set of main experiments showed that the DIAS population solves n-XOR with n=1, 2, and 3 reliably (FIGS. 3a, 3b, 3c). Even with 10 percent reward noise, the system is resilient and the population collectively achieves the best possible reward, even if it is not constant over time (FIGS. 4a, 4b, 4c). In comparison, while DE solved the 1-XOR in less than 10,000 time intervals in nine of 10 runs, only three runs solved the 2-XOR and none solved the 3-XOR within 100,000 time intervals. These results show that DIAS provides an advantage in scaling to problems with higher dimensionality and complexity. No runs lead to extinction, though some do not completely solve the problem within the allotted 200,000 time intervals as indicated in the figures.

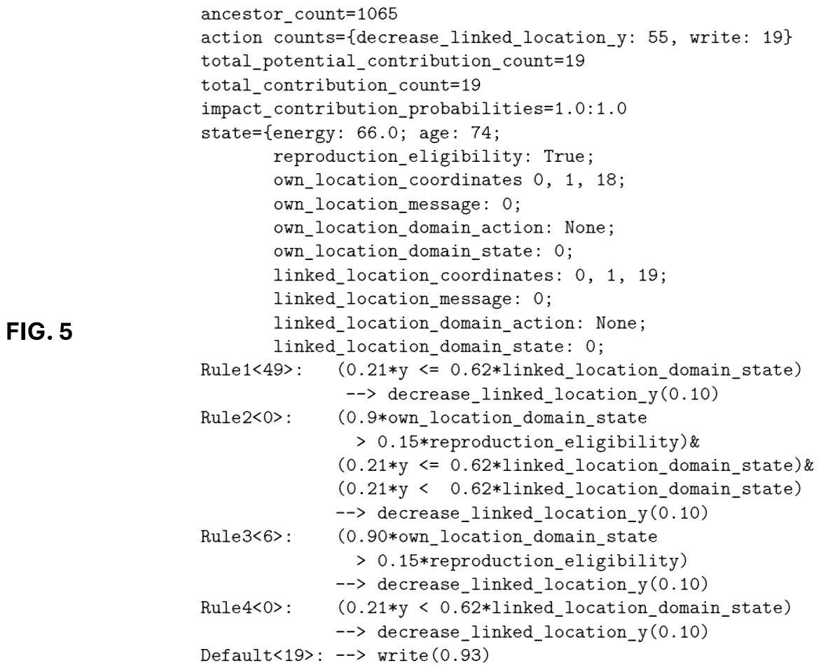

The success was due to emergent collaborative behavior of the actor population. This result can be seen by analyzing the rule sets that evolved, for example that of the actor from a population that solved the 1-XOR problem, shown in FIG. 5. The rules sets consist of a number of metrics, current state, and a set of rules. The ‘write’ action writes its argument in the own_location_domain_action field as the actor's suggested domain action αₓ. This actor is number 1065 in its lineage. It has contributed to the domain action 19 times, and all 19 times, its contribution has been in line with the domain action issued. Therefore, the vector of alignment probabilities pi at each impact level i has only one element: The probability is 1.0 for the impact level of 1.0. Its current state is high in energy for its age, suggesting that it has contributed well. Its current linked location has null values in message, domain-action, and domain-state fields. Even though the rules explicitly describe the actor's behavior, it is not possible to tell from this one actor what the solution to the complete problem is. The actor does not see the whole problem or determine the outcome alone: The population as a whole collectively solves it.

In terms of rules, the second and fourth are redundant, and never fired (redundancy is common in evolution because it makes the search more robust). Rule 1 fired 49 times, Rule 3 six times, and the default rule 19 times. Rules 1 and 3 perform a search for a linked location that has a large enough domain-state value: They decrease the y-coordinate of the linked lo-cation whenever they fire. If such a location is found (Rule 1), and its own domain-state value is high enough (Rule 3), 0.93 is written as its suggested domain action αₓ (Default rule). An αₓ>0.5 denotes a prediction that the XOR output is 1, while αₓ≤0.5 suggests that it is 0; therefore, this actor contributes to predicting XOR output 1. Other actors are required to generate the proper domain actions in other cases. Thus, problem solving is collective: Several actors need to perform compatible subtasks in order to form the whole solution.

### Solving Different Kinds of Problems

The second set of main experiments was designed to demonstrate the generality of DIAS, i.e. that it can solve a number of different problems out of the box, with no change to its settings. CartPole, MountainCar, Acrobot, and LunarLander of OpenAI Gym were used in this role because they represent a variety of well-known reinforcement-learning problems.

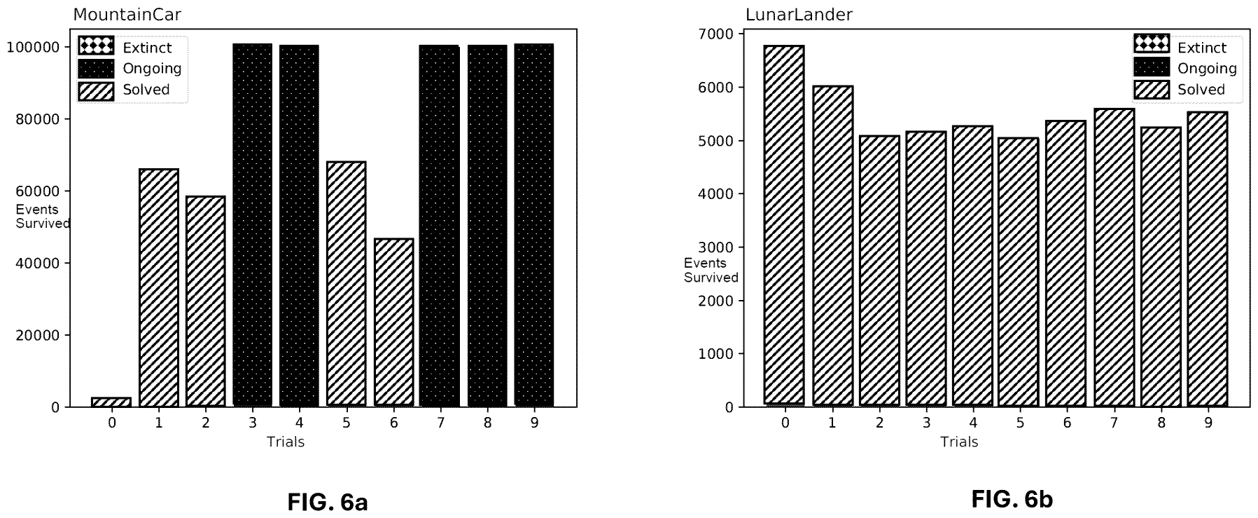

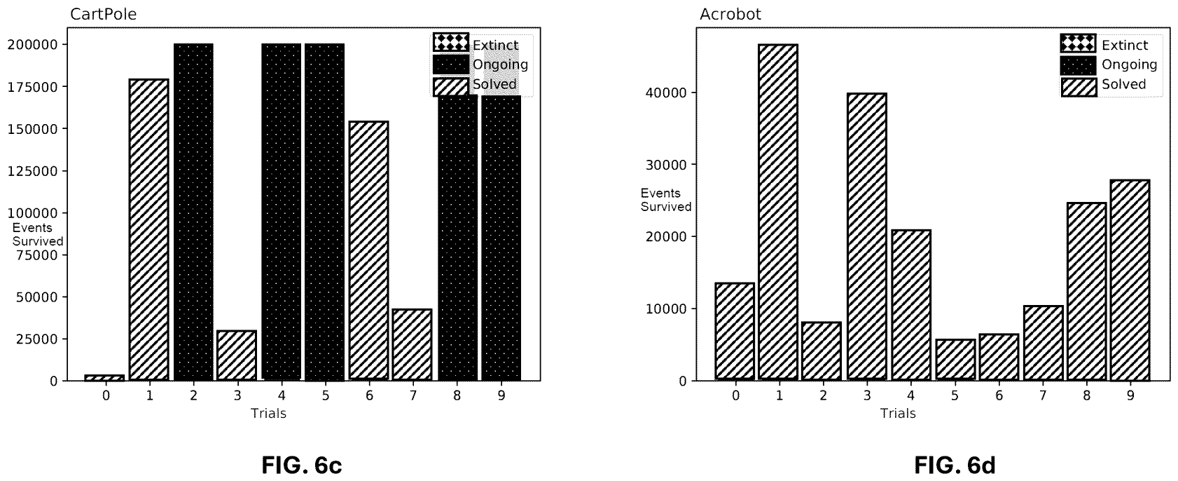

DIAS was indeed able to solve each of these problems without any customization, and with the same settings as the n-XOR problems (FIGS. 6a, 6b, 6c, 6d). Results of 10 runs in the MountainCar (FIG. 6a), LunarLander (FIG. 6b), CartPole (FIG. 6c), and Acrobot (FIG. 6d) problems are shown. Again, no runs resulted in extinction, although some MountainCar and Cartpole runs did not completely solve the problem within the allotted maximum number of time intervals. Notably, DIAS solves all these problems, as well as all other domains described herein, with the same hyperparameter and experimental settings, demonstrating the generality of the approach.

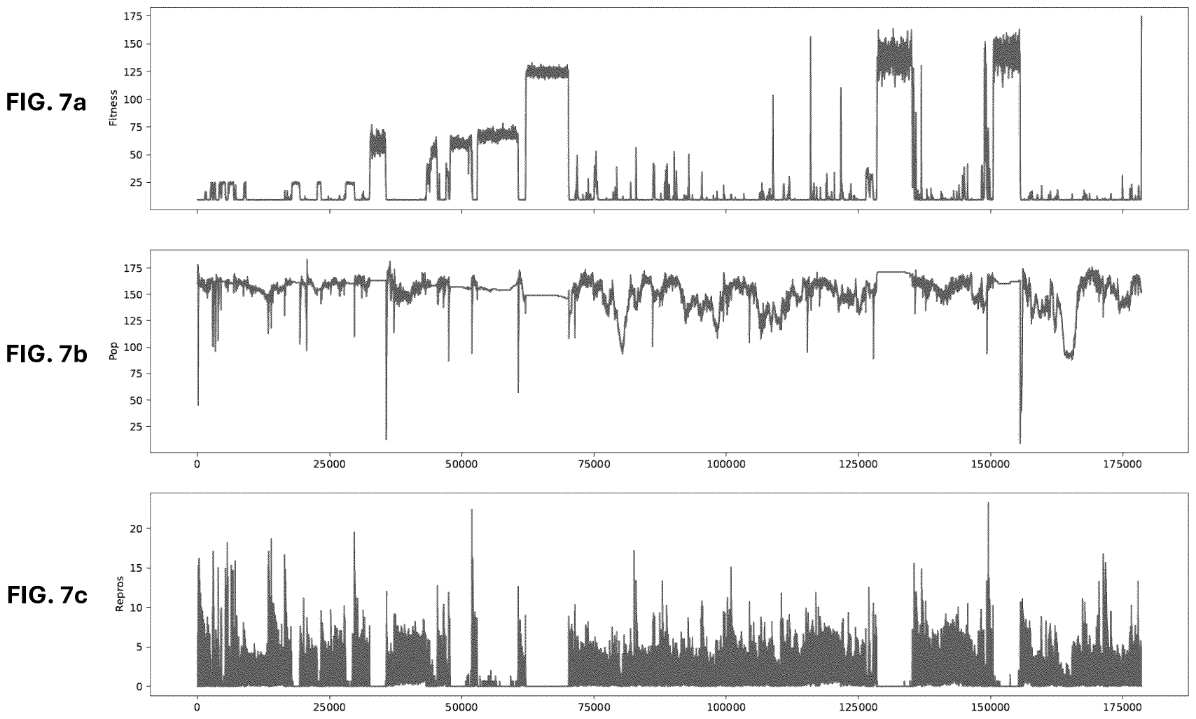

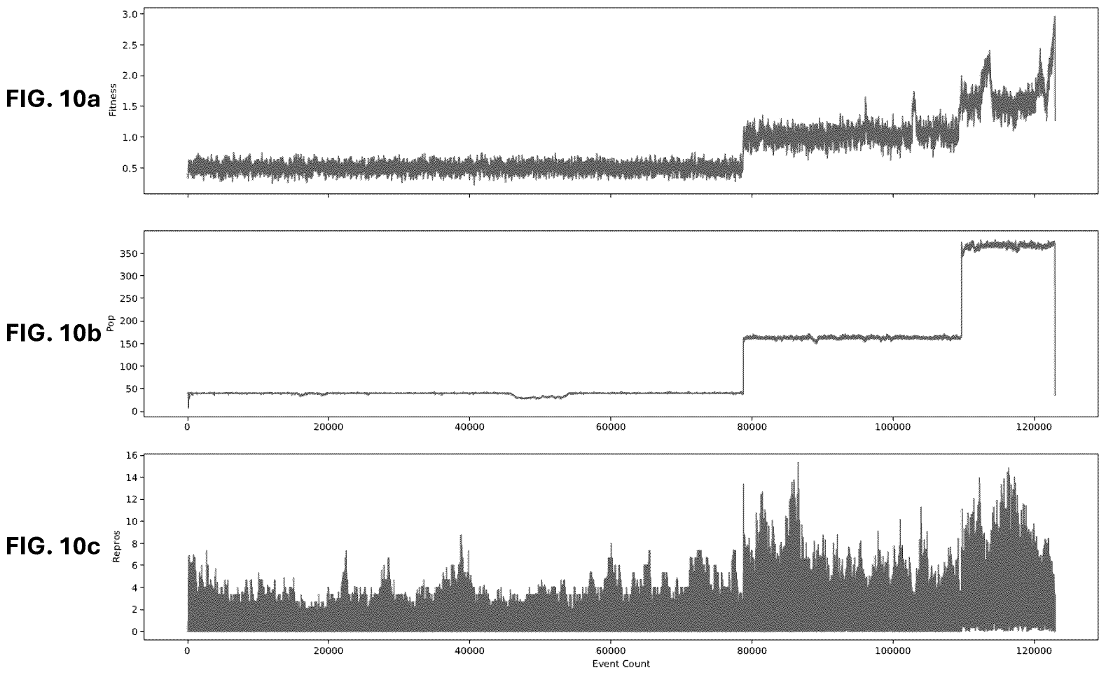

A histogram of the population dynamics as the ecosystem evolves to a solution is shown in FIGS. 7a, 7b, 7c for the CartPole problem. The figures show progression of domain fitness F (the number of time steps the pole stays upright; FIG. 7a), number of live actors (FIG. 7b), and the number of reproductions (FIG. 7c) at each time interval. The reproductions drop and the population becomes relatively stable during periods when the ecosystem finds a peak in F; however, these peaks are unstable and the population eventually moves on to explore other solutions. The system gradually finds higher domain fitness peaks, and every time it does so, the number of reproductions drop and the population stabilizes. In this manner, DIAS is trying out different equilibria, eventually finding one that implements the best solution. Such dynamics make it possible to not only find solutions to the current problem, but to also adapt rapidly to changing domains and new problems (as seen in FIG. 10a, 10b, 10c).

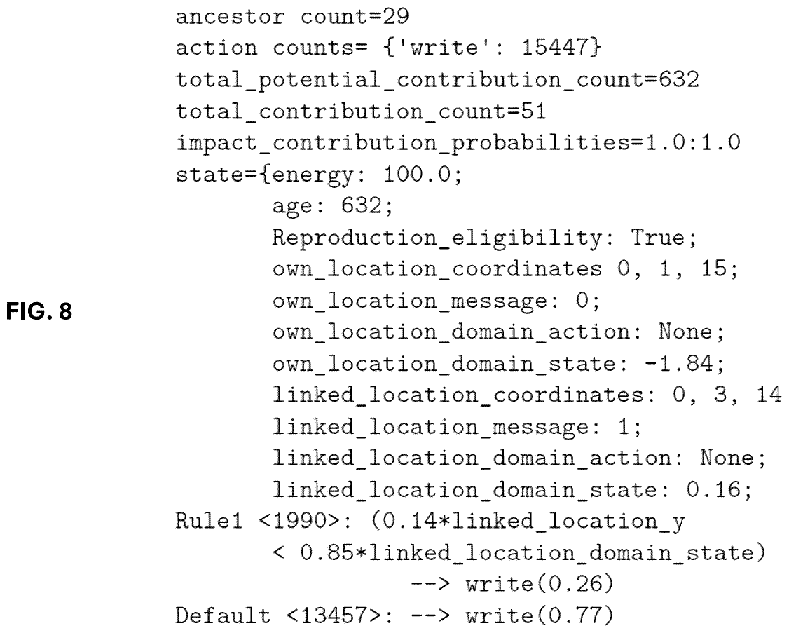

An example actor from a population that solved the CartPole domain is shown in FIG. 8. In this case, the actor is relying on the domain-state value in the linked location, S_{y}′, to be large enough (currently (3*0.14)/0.85=0.49), writing 0.26 (to its own_location_action αₓ) when this is the case (Sy with y=3), and 0.77 otherwise. In other words, it suggests a left push when the fourth element of the domain state is large, otherwise a right push. It is difficult to tell what role this actor plays in the overall solution, but clearly, it does not contain the complete solution to the CartPole problem. As with the n-XOR domain, the population discovers and represents the solutions collectively.

### Adapting to Changing Problems

A third set of experiments were run in the n-XOR domain to demonstrate the system's ability to switch between domains mid-run. The run starts by solving the 1-XOR problem; then the problem switches to 2-XOR, 3-XOR, and back to 1-XOR again. Note that the max domain fitness level also changes mid-run as problems are switched. These switches require the geo to expand and retract, as the dimension of x (i.e. number of domain actions) and y (number of domain states) are different between problems. This change, however, does not affect the actors, whose action and state spaces remain the same. When retracting, actors in locations that no longer exist are removed from the system. When expanding, new actors are created in locations (i, j, k) with i>x and/or j>y by du-plicating the actor in location (i mod x, j mod y, k), if any.

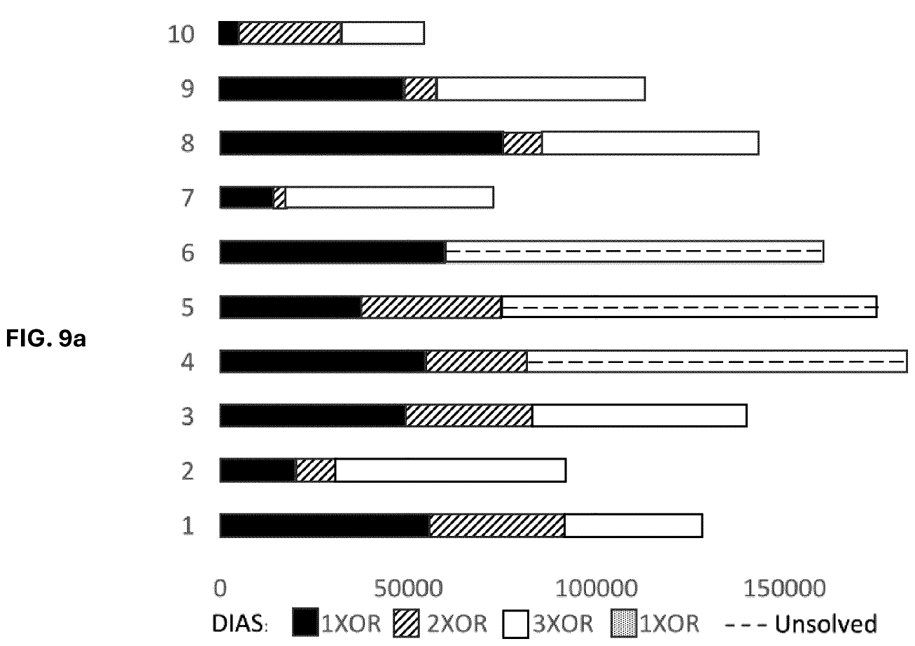

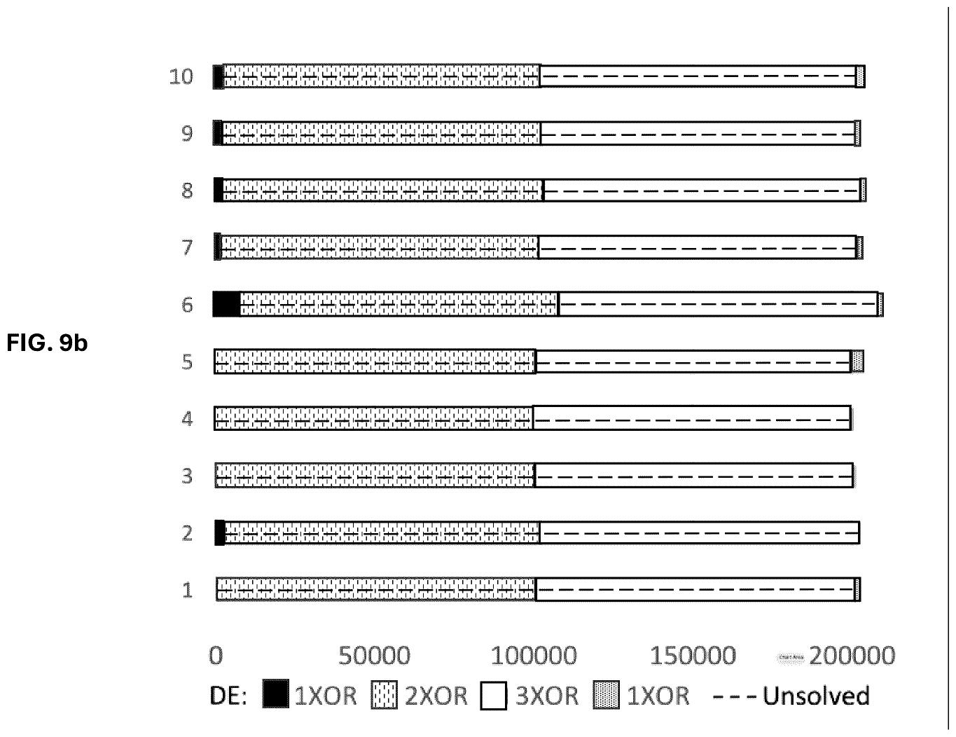

The results of 10 such runs comparing DIAS and DE are shown in FIGS. 9a and 9b. Ten runs of DIAS (FIG. 9a) and DE (FIG. 9b) are shown where the problem switched from 1-XOR to 2-XOR, 3-XOR, and back to the 1-XOR as soon as the problem was solved or 100,000 time intervals passed (dashed line). DIAS was able to adapt to new problems quickly, solve new problems quicker, and particularly quickly when returning to 1-XOR. In contrast, while DE solved the first 1-XOR quickly, it was not able to adapt to 2-XOR nor 3-XOR mid-run, and it did not solve the second 1-XOR faster than the first. Thus, collective problem solving in DIAS provides a significant advantage in adapting to new problems, i.e. in lifelong learning. In seven of these runs, DIAS was able to solve the entire sequence of problems. Most interestingly, the time DIAS needed for subsequent problems often became shorter. For example Run 1 took 55,574 time intervals to solve the 1-XOR problem, another 35,363 to solve the 2-XOR, and 36,690 more to solve the 3-XOR. Then, switching back to the 1-XOR problem, a solution was found within a mere 51 time intervals. The dynamics of these adaptations, shown in FIGS. 10a, 10b, 10c, take advantage of similar unstable equilibria as shown in FIGS. 7a, 7b, 7c. As in FIGS. 7a, 7b, 7c, progression of rewards is shown in FIG. 10a, population size in FIG. 10b, and reproduction count in FIG. 10c. Throughout the run, problem dimensionality and complexity varies, and even the maximum achievable domain fitness changes. However, the same population is able to explore and solve new problems, demonstrating lifelong learning. As a result, DIAS is able to adapt to new problems quickly, retain information from earlier problems, utilize it in later problems, and avoid catastrophic forgetting when returning to old problems.

In contrast, while DE solved the 1-XOR fast in the beginning and end of each sequence, none of its 10 runs were able to adapt to 2-XOR and 3-XOR mid-run. Also, it did not solve the second 1-XOR any faster than the first one.

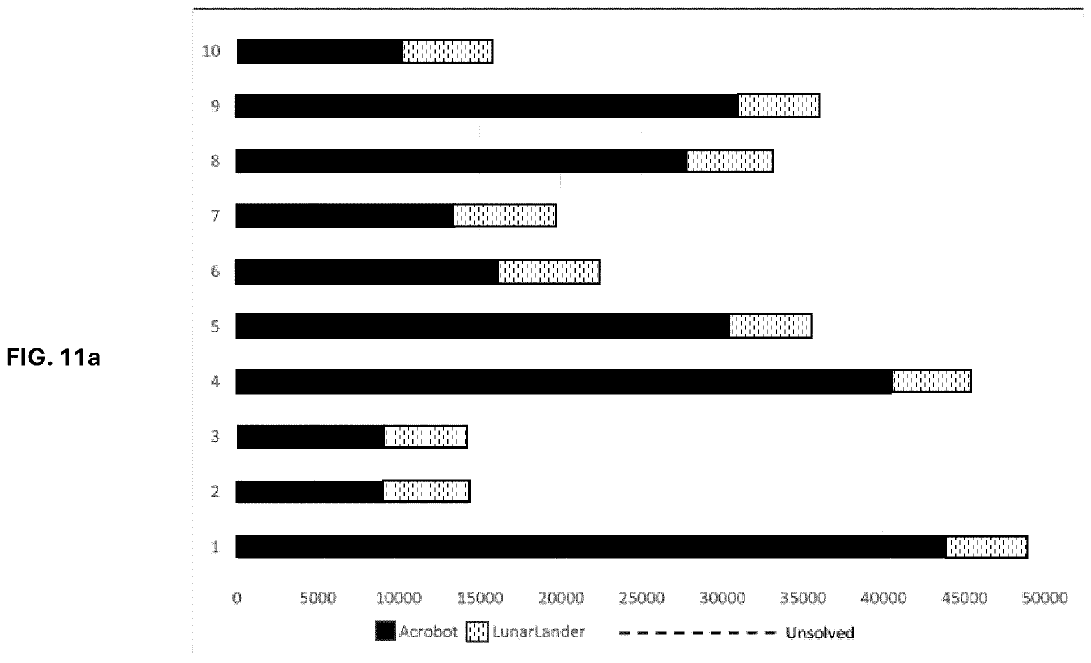

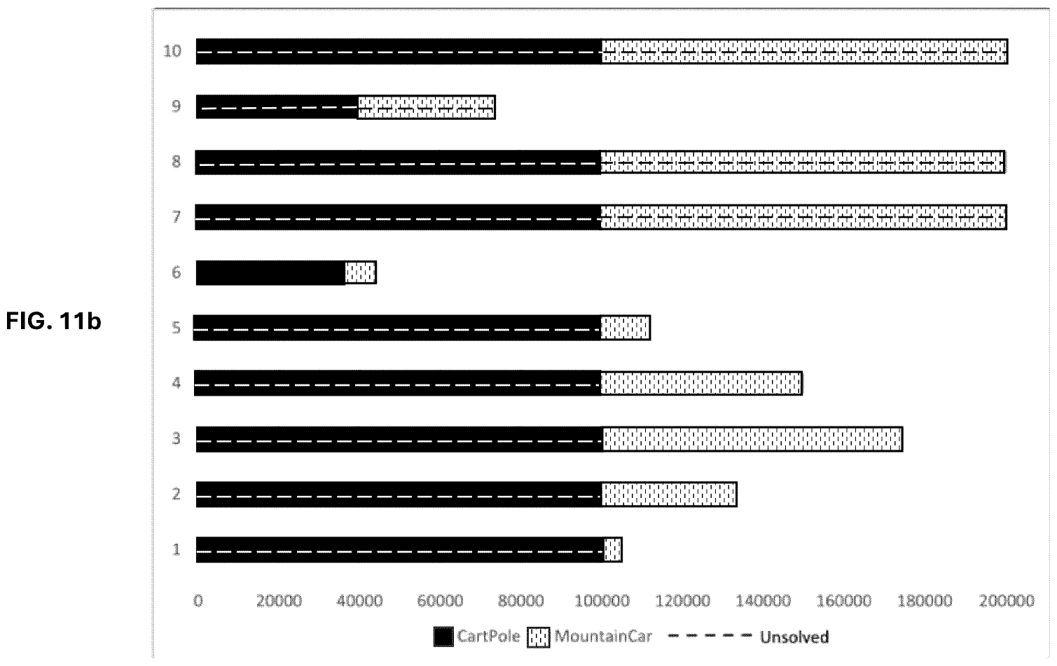

In a further problem-switching experiment (FIGS. 11a, 11b), DIAS was required to adapt between two easy and two hard OpenAI Gym problems. In FIG. 11a, the problem switched from Acrobot to LunarLander. Both of these problems are easy to solve in the allotted 100,000 intervals (as can be seen in FIGS. 6a, 6b, 6c, 6d), and DIAS adapts to the switch easily. In FIG. 11b, the problem switched from CartPole to MountainCar once the problem was solved or 100,000 time intervals passed. Interestingly, whether it found a solution to CartPole within the 100,000 intervals or not, it still switched successfully to MountainCar and found solutions in most cases, and actually more often than expected based on FIGS. 6a, 6b, 6c, 6d. Both of these problems are difficult and in many cases the switch occurs while DIAS is still working on solving the first problem. Yet DIAS is often able to solve the second problem just the same, and actually more often than expected based on FIGS. 6a, 6b, 6c, 6d. Thus, DIAS adapts robustly to both easy and hard problem switches.

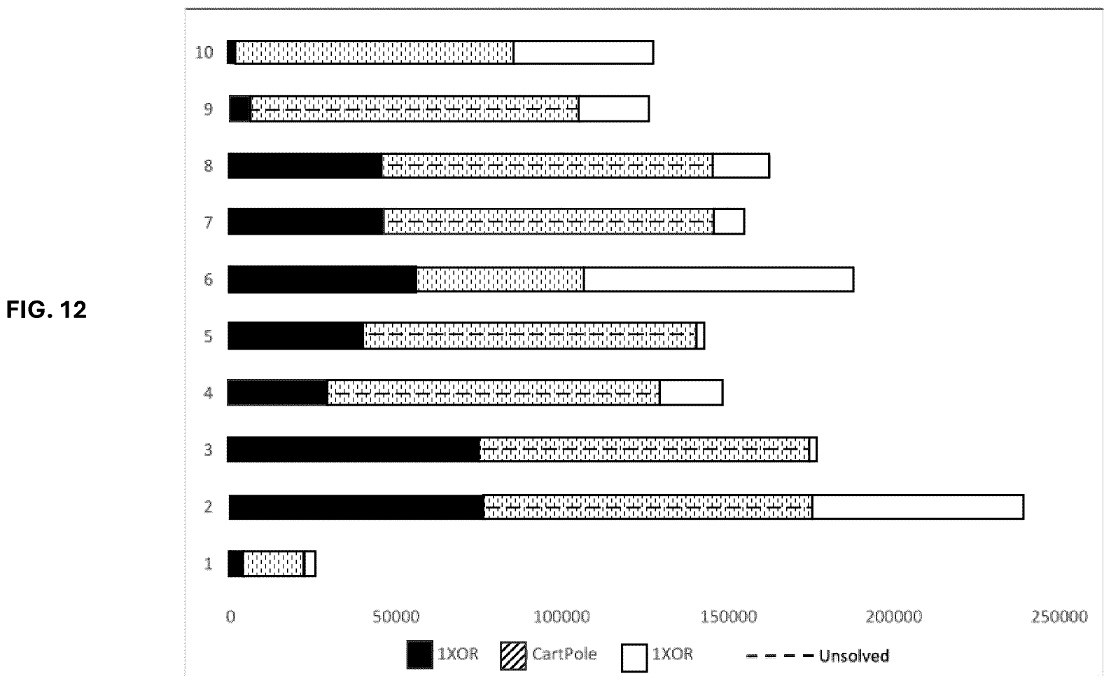

Further, as shown in FIG. 12, DIAS was able to switch between different domains, i.e. from 1-XOR to CartPole and back as soon as the problem was solved or 100,000 time intervals passed, and again adapt faster to the second 1-XOR. DIAS was able to adapt as expected, solving CartPole in three of the ten runs, and also solve the second 1-XOR quicker in seven of the ten cases. These results demonstrate that DIAS can adapt robustly across many different domain switches: easy, hard, converged, ongoing, familiar, and unfamiliar.

More generally, the experiments show that the collective problem solving in DIAS is essential for solving new problems continuously as they appear, and for retaining the ability to solve earlier problems. In this sense, it demonstrates an essential ability for continual, or lifelong, learning. It also demonstrates the potential for curriculum learning for more complex problems: The same population can be set to solve domains that get more com-plex with time. Such an approach may have a better chance of solving the most complex problems than one where they are tackled directly from the beginning.

These experiments thus show that the collective problem solving in DIAS is essential for solving new problems continuously as they appear, and for retaining the ability to solve earlier problems. In this sense, it demonstrates an essential ability for continual, or lifelong, learning. It also demonstrates the potential for curriculum learning for more complex problems: The same population can be set to solve domains that get more complex with time. Such an approach may have a better chance of solving the most complex problems than one where they are tackled directly from the beginning.

The experimental results with DIAS are promising: They demonstrate that the same system, with no hyperparameter tuning or domain-dependent tweaks, can solve a variety of domains, ranging from classification to reinforcement learning. The results also demonstrate ability to switch domains in the middle of the problem-solving process, and potential benefits of doing so as part of curriculum learning. The system is robust to noise, as well as changes to its domain-action space and domain-state space mid-run.

The most important contribution of this work is the introduction of a common mapping between a domain and an ecosystem of actors. This mapping includes a translation of the state and action spaces, as well as a translation of domain rewards to the actors contributing (or not contributing) to a solution. It is this mapping that makes collective problem solving effective in DIAS. With this mapping, changes to the domain have no effect on the survival task that the actors in the ecosystem are solving. As a result, the same DIAS system can solve problems of varying dimensionality and complexity, solve different kinds of problems, and solve new problems as they appear, and do it better than DE can.

In this process, interesting collective behavior analogous to biological ecosystems can be observed. Most problems are being solved through emergent cooperation among actors (i.e. when x and/or y-dimensionality>1). Problem solving is also continuous: The system regulates its population, stabilizing it as better solutions are found. Because of this cooperative and continual adaptation, it is difficult to compare the experimental results to those of other learning systems. Solving problems of varying scales, different problems, and tracking changes in the domain generally requires domain-dependent set up, discovered through manual trial and error. A compelling direction for the future is to design benchmarks for domain-independent learning, making such comparisons possible and encouraging further work in this area.

In the future, a parallel implementation of DIAS should speed up and scale up problem-solving, making it possible to run DIAS even with large search spaces in reasonable time. Each actor would run in its own process, synchronized locally only in the event of reproduction with another actor. By restricting the scope of an actor's neighborhood, even the geo could potentially be distributed over multiple machines.

For high-dimensional domain-state and domain-action spaces, it may also be possible to fold the axes of the geo so that a single (x, y) location can refer to more than one state or action in the domain space. This generalization, of course, would come at the expense of larger actor-action and actor-state space because each location would now have more than one value for domain state and action, but it could make it faster with high-dimensional domains.

Another potential improvement is to design more actor types. While rule-set evolution performed well, it is a very general method, and it may be possible to design other methods that more rapidly and consistently adapt to specific problem domains as part of the DIAS framework. In particular, gradient-based reinforcement learning actor types such as the DQN actor work well in simulation-based multi-agent systems where actor policies can be trained against many runs but do not currently extend well to continual learning that is a main strength of DIAS. It would be interesting to augment the gradient-based learning in the DQN Actor type with evolution of weights and/or architecture based on the changing problem requirements.

The embodiments herein describe a domain-independent problem-solving system that can address problems with varying dimensionality and complexity, solve different problems with little or no hyperparameter tuning, and adapt to changes in the domain, thus implementing lifelong learning. These abilities are based on artificial-life principles, i.e. collective behavior of a population of actors in a spatially organized geo, which forms a domain-independent problem-solving medium. Experiments with DIAS demonstrate an advantage over a direct problem-solving approach, thus providing a promising foundation for scalable, general, and adaptive problem solving in the future.

One skilled in the art will appreciate the system architecture and components which may be used to implement the experiments described in the present embodiments. One or more computing devices may be used to implement the functionalities described with the FIGS. and herein. The computing device includes, inter alia, processing and memory components which may be attached to one or more motherboards or fabricated onto a single system on a chip (SoC) die. Processing components may include one or more processing devices, one or more of the same type of processing device, one or more of different types of processing device. The processing device may include electronic circuitry that process electronic data from data storage elements (e.g., registers, memory, resistors, capacitors, quantum bit cells) to transform that electronic data into other electronic data that may be stored in registers and/or memory. Exemplary processing devices may include a central processing unit (CPU) (e.g., Xeon scalable processors or AMD Epyc processors), a graphical processing unit (GPU) (E.g., Nvidia P100, V100, A100, T4), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU). In addition to processing unit memory, additional memory components may include one or more memory devices such as volatile memory (e.g., DRAM), nonvolatile memory (e.g., read-only memory (ROM)), high bandwidth memory (HBM), flash memory, solid state memory, and/or a hard drive. Memory includes one or more non-transitory computer-readable storage media. The memory may include memory that shares a die with the processing device. The memory includes one or more non-transitory computer-readable media storing instructions executable to perform operations described herein. The instructions stored in the one or more non-transitory computer-readable media are executed by processing component(s). The memory component(s) may store data, e.g., data structures, binary data, bits, metadata, files, blobs, etc. The computing architecture may include a network of clustered systems having multiple 10 gbps or higher Ethernet interfaces, InfinBand or dedicated GPU (NVLink) interfaces for intracluster communications.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the features of the embodiments and does not pose a limitation on the scope of the embodiments unless otherwise claimed. No language in the specification should be construed as indicating any non-claimed element as essential to the practice of the embodiments.

Preferred embodiments are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, these embodiments includes all modifications and equivalents of the subject matter recited in the claims appended hereto as permitted by applicable law. Moreover, any combination of the above-described elements in all possible variations thereof is encompassed by the embodiments unless otherwise indicated herein or otherwise clearly contradicted by context.

1. A domain-independent evolutionary process for solving a problem, the process comprising:
initializing a first population of independent, individual actors existing on a three-dimensional (x, y, z) grid, wherein x is elements of a domain-action vector, y is elements of a domain-state vector, and z is a space for messaging, and further wherein each of the individual actors is initialized to solve the problem by;
(i) applying each of the individual actors to the problem during a first time interval in an attempt to solve the problem until the first time interval is terminated;
(ii) determining fitness F of the population of individual actors to solve the problem during the first time interval;
(iii) assigning credit to the determined fitness F to individual actors, wherein each individual actor's credit is f,
(iv) removing individual actors based on at least a change in energy Δe;
(v) selecting multiple individual actors for procreation having credit values above a minimum requirement for f,
(vi) generating new individual actors by procreating the selected multiple individual actors;
(vii) adding the new individual actors to the first population to establish a second population of individual actors; and
repeating steps (i) to (vii) for a predetermined number of time intervals or until a solution to the problem is discovered.

2. The domain-independent evolutionary process of claim 1, wherein each individual actor's credit is f is a function of each individual actor's contribution c to a domain impact M, wherein M is determining by converting the determined fitness F into domain impact M, wherein M is normalized based a maximum fitness Fₘₐₓ_{_{R}} and minimum fitness Fₘᵢₙ_{_{R}} observed over a past R evaluations of the actor as M=(F−Fₘᵢₙ_{_{R}})/(Fₘₐₓ_{_{R}}−Fₘᵢₙ_{_{R}}); and
the contribution c of each individual actor to M is measured as an alignment of an actor's domain-action suggestions αₓ with actual action elements Aₓ issued to the domain during the time interval as follows
$$c = 1 - {min}_{t = 0 … T} ( \vert {A}_{x} ( t ) - {a}_{x} ( t ) \vert ) ,$$
where T is the termination time.

3. The domain-independent evolutionary process of claim 2, wherein selecting multiple individual actors for procreation includes
discretizing M into L levels M={b₀, b₁ . . . , b_{L-1}}, wherein for each of these levels bᵢ, the probability pᵢ that the actor's action suggestions align with the actual actions when M=bᵢ is estimated as
$${p}_{i} = P ( c = 1 \vert M = {b}_{i} ) ,$$
and
calculating f as
$$f = {{\sum }_{i = 0}}^{L} {p}_{i} {b}_{i} .$$

4. The domain-independent evolutionary process of claim 2, wherein the change in energy Δe is determined using a fixed cost h and a reward that is dependent on the impact M and the actor's contribution to M during the time interval as follows
$$Δ e = h ( cM ( 1 - c ) ( 1 - M ) - 1 ) ;$$
wherein when an actor's Δe≤0, removing the actor from the population.

5. The domain-independent evolutionary process of claim 1, where the actors are selected from a group consisting of: randomly selecting a next action; selects its next action based on preprogrammed rules specific to the domain, providing a performance ceiling; selecting its next action using a UCB-1 algorithm; selecting its next action using Q-values learned through temporal differences; evolving a set of rules to select its next action.

6. A domain-independent evolutionary process for solving a problem, the process comprising:
establishing three-dimensional grid including domain-action space along the x-axis and domain-state space along the y-axis, wherein domain action is a vector A including one or more elements Aₓ mapped to a different x-location and domain state is a vector S including elements Sy mapped to different y-locations;
mapping a first population of actors to different (x, y, z) locations the grid, wherein there are one or more actors for each (x, y)-location of the grid and for each actor, actor-state and actor-action exist independent of domain;
during each domain time step t, loading a current domain-state vector S into the grid, wherein each (x, y, z) location is updated with S domain-state element S_{y};
inputting by each actor in the first population its current actor state vector σ;
issuing by each actor, one of an action α or no action as output, wherein
when an action α is output, further writing a domain-action suggestion αₓ in their location creating a domain-action vector A and averaging domain-action suggestions αₓ are averaged across all locations with the same x to form its elements Aₓ,
when no aₓ were written, Aₓ(t−1) is used with Aₓ(−1)=0 and a resulting action vector A is passed to the domain, which executes it, resulting in a new domain state.

7. The domain-independent evolutionary process of claim 6, wherein an actor-action vector α is selected from the following group consisting of: write a domain-action suggestion aₓ in the current location in the grid; write a message in the current location in the geo; write actor's reproduction eligibility; move to a geographically adjacent grid location; change coordinates of a linked location; and NOP.

8. The domain independent evolutionary process of claim 6, wherein the actor-state vectors σ are selection from a group consisting of the following data: Energy e: real≥0; Age: integer≥0; Reproduction eligibility: True/False; coordinates in the current location: integer x, y, z≥0; message in the current location: [0 . . . 1]; domain-action suggestion aₓ in current location: [0 . . . 1]; domain-state value S_{y} in the current location: [0 . . . 1]; coordinates in a linked location: integer x′, y′, z′≥0; message in a linked location: [0 . . . 1]; domain-action suggestion aₓ′ in a linked location: [0 . . . 1]; domain-state value S_{y′} in a linked location: [0 . . . 1].

9. The domain-independent evolutionary process of claim 6, where the actors are selected from a group consisting of: randomly selecting a next action; selects its next action based on preprogrammed rules specific to the domain, providing a performance ceiling; selecting its next action using a UCB-1 algorithm; selecting its next action using Q-values learned through temporal differences; evolving a set of rules to select its next action.

10. At least one non-transitory computer readable medium programmed to implement a domain-independent evolutionary process for solving a problem, the process comprising:
initializing a first population of independent, individual actors existing on a three-dimensional (x, y, z) grid, wherein x is elements of a domain-action vector, y is elements of a domain-state vector, and z is a space for messaging, and further wherein each of the individual actors is initialized to solve the problem;
(i) applying each of the individual actors to the problem during a first time interval in an attempt to solve the problem until the first time interval is terminated;
(ii) determining fitness F of the population of individual actors to solve the problem during the first time interval;
(iii) assigning credit to the determined fitness F to individual actors, wherein each individual actor's credit is f,
(iv) removing individual actors based on at least a change in energy Δe;
(v) selecting multiple individual actors for procreation having credit values above a minimum requirement for f,
(vi) generating new individual actors by procreating the selected multiple individual actors;
(vii) adding the new individual actors to the first population to establish a second population of individual actors; and
repeating steps (i) to (vii) for a predetermined number of time intervals or until a solution to the problem is discovered.

11. The at least one non-transitory computer readable medium of claim 10, wherein each individual actor's credit is f is a function of each individual actor's contribution c to a domain impact M, wherein M is determining by converting the determined fitness F into domain impact M, wherein M is normalized based a maximum fitness Fₘₐₓ_{_{R}} and minimum fitness Fₘᵢₙ_{_{R}} observed over a past R evaluations of the actor as M=(F−Fₘᵢₙ_{_{R}})/(Fₘₐₓ_{_{R}}−Fₘᵢₙ_{_{R}}); and
the contribution c of each individual actor to M is measured as an alignment of an actor's domain-action suggestions αₓ with actual action elements Aₓ issued to the domain during the time interval as follows
$$c = 1 - {min}_{t = 0 … T} ( \vert {A}_{x} ( t ) - {a}_{x} ( t ) \vert ) ,$$
where T is the termination time.

12. The at least one non-transitory computer readable medium of claim 11, wherein selecting multiple individual actors for procreation includes
discretizing M into L levels M={b₀, b₁ . . . , b_{L-1}}, wherein for each of these levels bᵢ, the probability pᵢ that the actor's action suggestions align with the actual actions when M=bᵢ is estimated as
$${p}_{i} = P ( c = 1 \vert M = {b}_{i} ) ,$$
and
calculating f as
$$f = {{\sum }_{i = 0}}^{L} {p}_{i} {b}_{i} .$$

13. The at least one non-transitory computer readable medium of claim 11, wherein the change in energy Δe is determined using a fixed cost h and a reward that is dependent on the impact M and the actor's contribution to M during the time interval as follows
$$Δ e = h ( c M ( 1 - c ) ( 1 - M ) - 1 ) ;$$
wherein when an actor's Δe≤0, removing the actor from the population.

14. The at least one non-transitory computer readable medium of claim 10, where the actors are selected from a group consisting of: randomly selecting a next action; selects its next action based on preprogrammed rules specific to the domain, providing a performance ceiling; selecting its next action using a UCB-1 algorithm; selecting its next action using Q-values learned through temporal differences; evolving a set of rules to select its next action.
